(19) United States
(12) Patent Application Publication
(10) Pub. No.: US 2024/0328247 A1
(43) Pub. Date: Oct. 3, 2024

(54) WINDOW SHADE

(71) Applicant: Teh Yor Co., Ltd., New Taipei City (TW)

(72) Inventors: Chin-Tien HUANG, New Taipei City (TW); Yu-Ling LIU, New Taipei City (TW)

(73) Assignee: Teh Yor Co., Ltd., New Taipei City (TW)

(21) Appl. No.: 18/613,989

(22) Filed: Mar. 22, 2024

Related U.S. Application Data
(60) Provisional application No. 63/456,385, filed on Mar. 31, 2023.

(51) Int. Cl. E06B 9/42; E06B 9/80; F16M 13/02

(52) U.S. Cl. CPC E06B 9/42; E06B 9/80; F16M 13/02; E06B 2009/801

(57) ABSTRACT

A window shade comprises a shade assembly that includes a roller connected to a shade structure, and has a first end coupled to a first bracket and a second end having a coupler, the roller being pivotally connected to the first bracket. The first bracket is provided with a roller lock movable between a locking position where the roller lock rotationally locks the roller to prevent rotation of the roller relative to the first bracket, and an unlocking position where the roller lock rotationally unlocks the roller for rotation of the roller relative to the first bracket. Moreover, the window shade includes a connector and a second bracket attachable to a support surface of a building, wherein the first bracket and the coupler are respectively connected to the connector and the second bracket when the shade assembly is mounted to the support surface of the building.

### CROSS-REFERENCE TO RELATED APPLICATION(S)

This application claims priority to U.S. provisional patent application No. 63/456,385 filed on Mar. 31, 2023, the disclosure of which is hereby incorporated by reference.

### BACKGROUND

### 1. Field of the Invention

The present invention relates to window shades.

### 2. Description of the Related Art

Vertically adjustable window shades, such as roller shades and cellular shades, generally have a head rail that can be fastened to a support surface in a house with screws so that a shade panel can be expanded vertically from the head rail for covering a window opening. The conventional window shades do not allow easy deinstallation, which may render repair and/or cleaning operations cumbersome. Since the head rail is conventionally formed as an elongate component extending along the entire width of the shade panel, the size of the head rail also contributes to add weight to the window shade.

### SUMMARY

The present application provides a window shade that is easy to install, can reduce weight, and address at least the aforementioned issues.

According to one embodiment, a window shade comprises a shade assembly including a roller and a shade structure connected to each other, the shade assembly having a first end and a second end opposite to each other, the first end being coupled to a first bracket, the second end having a coupler, the roller being pivotally connected to the first bracket. The first bracket is provided with a roller lock movable between a locking position where the roller lock rotationally locks the roller to prevent rotation of the roller relative to the first bracket, and an unlocking position where the roller lock rotationally unlocks the roller for rotation of the roller relative to the first bracket. Moreover, the window shade includes a connector and a second bracket attachable to a support surface of a building, wherein the first bracket and the coupler are respectively connected to the connector and the second bracket when the shade assembly is mounted to the support surface of the building.

### BRIEF DESCRIPTION OF THE DRAWINGS

FIG. 1 is a perspective view illustrating an embodiment of a window shade;

FIG. 2 is an exploded view illustrating construction details of the window shade;

FIGS. 3 and 4 are perspective views under different angles of view illustrating construction details of a bracket and a coupler at one end of a shade assembly of the window shade;

FIG. 5 is a cross-sectional view illustrating the bracket and the coupler shown in FIGS. 3 and 4 connected to each other;

FIG. 6 is perspective view illustrating construction details of a connector and another bracket at another end of the shade assembly;

FIG. 7 is a perspective view illustrating the connector alone;

FIGS. 8-12 are schematic views illustrating exemplary operation for mounting the window shade to a support surface of a building;

FIGS. 13 and 14 are schematic views illustrating exemplary operation for removing the shade assembly of the window shade from the support surface of the building;

FIG. 15 is a perspective view illustrating a variant embodiment of the window shade;

FIG. 16 is an exploded view illustrating a portion of the window shade shown in FIG. 15;

FIGS. 17 and 18 are perspective views illustrating construction details of a roller lock provided in the window shade of FIG. 15;

FIG. 19 is a schematic view illustrating a stop mechanism for holding the roller lock in an unlocking position; and

FIG. 20 is a schematic view illustrating another stop mechanism for holding the roller lock in a locking position.

### DETAILED DESCRIPTION OF THE EMBODIMENTS

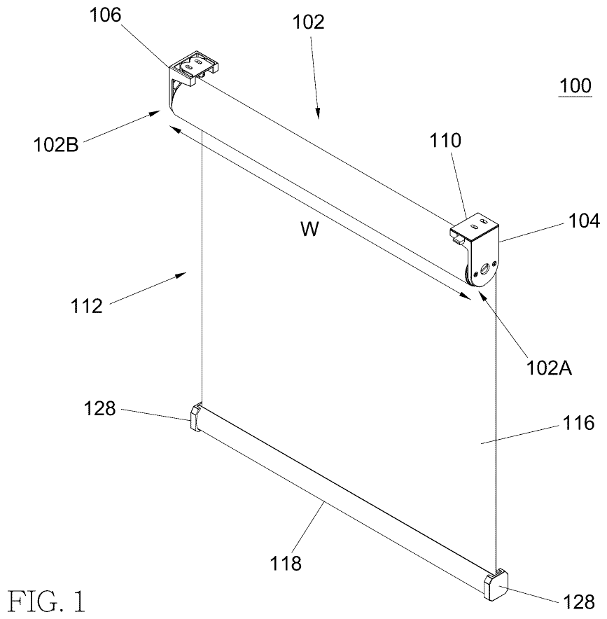

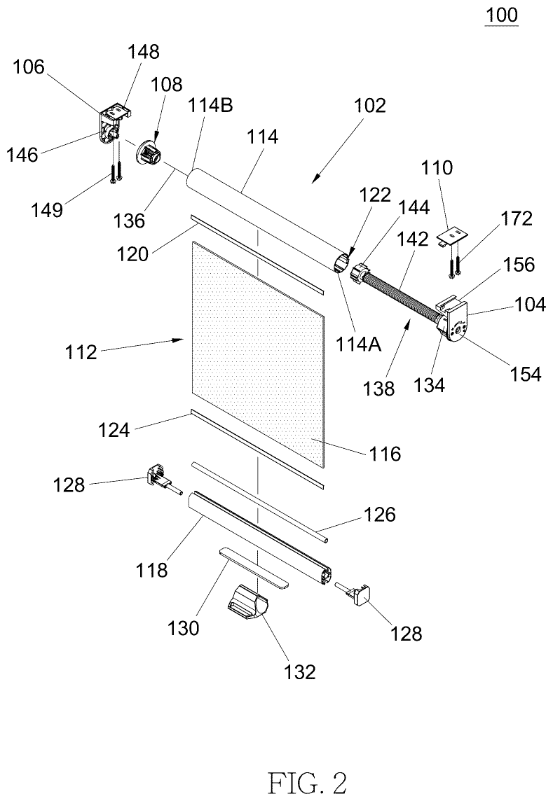

FIG. 1 is a perspective view illustrating an embodiment of a window shade 100, and FIG. 2 is an exploded view illustrating construction details of the window shade 100. Referring to FIGS. 1 and 2, the window shade 100 can include a shade assembly 102, two brackets 104 and 106, a coupler 108 and a connector 110. The shade assembly 102 can have a width dimension W, and two ends 102A and 102B opposite to each other along the width dimension W. The bracket 104 and the connector 110 can be disposed at the end 102A of the shade assembly 102, and the bracket 106 and the coupler 108 can be disposed at the other end 102B of the shade assembly 102. To reduce the weight of the window shade 100, the illustrated example has no head rail or fixed structure between the two brackets 104 and 106. However, some alternate constructions may optionally provide a cover between the two brackets 104 and 106 for protection and/or aesthetic purposes.

The shade assembly 102 includes a shade structure 112, and is operable to expand and retract the shade structure 112. According to an example of construction, the shade assembly 102 can include a roller 114, and the shade structure 112 can be connected to the roller 114. The roller 114 is formed as a tube, and has two opposite ends 114A and 114B respectively corresponding to the two ends 102A and 102B of the shade assembly 102. The roller 114 is pivotally connected to the bracket 104, and is rotatable to wind and unwind the shade structure 112. For example, the shade structure 112 can be wound around the roller 114 for retraction, and can be unwound from the roller 114 for expansion.

Referring to FIGS. 1 and 2, the shade structure 112 may have any suitable constructions. According to an example of construction, the shade structure 112 can include a panel 116, and a bottom rail 118 connected to the panel 116. The panel 116 may include a fabric sheet having an upper end affixed to the roller 114 and a lower end affixed to the bottom rail 118. According to another example of construction, the panel 116 may have a cellular structure (not shown) formed by multiple fabric strips bonded to one another and/or to a support sheet.

The upper end of the panel 116 may be provided with an anchor strip 120, which can be inserted into a groove 122 provided on an outer surface of the roller 114 for affixing the upper end of the panel 116 to the roller 114. The lower end of the panel 116 can be likewise provided with an anchor strip 124, which can be inserted into the bottom rail 118. A rod 126 can be fitted inside the bottom rail 118 so that a portion of the panel 116 can be clamped between the bottom rail 118 and the rod 126. Once the lower end of the panel 116 is affixed to the bottom rail 118, the two opposite ends of the bottom rail 118 can be closed with two end caps 128. A weighing element 130 may be added inside the bottom rail 118 for more stability, and a handle 132 may be optionally provided on the bottom rail 118 for facilitating manual operation by a user.

Referring to FIGS. 1 and 2, the end 114A of the roller 114 may be pivotally connected to the bracket 104 via a coupler 134. For example, the coupler 134 can be mounted to the bracket 104 for rotation about a pivot axis 136, and can be fitted at least partially into the end 114A of the roller 114 so that the roller 114 and the coupler 134 can rotate in unison about the pivot axis 136 relative to the bracket 104.

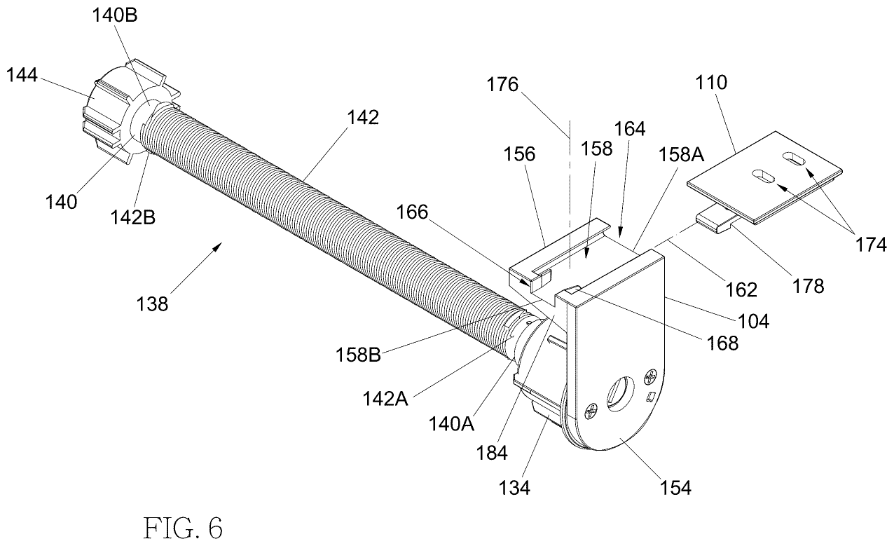

Referring to FIGS. 1 and 2, the shade assembly 102 can further include a torsion spring assembly 138 disposed inside the roller 114. The torsion spring assembly 138 is better shown in FIG. 6. The torsion spring assembly 138 can apply a biasing torque to the roller 114 in a direction for winding the shade structure 112, which can assist in counteracting a downward force applied upon the shade structure 112 owing to gravity action. According to an example of construction, the torsion spring assembly 138 can include a shaft 140 and a torsion spring 142 that are disposed inside the roller 114. The shaft 140 can have an end 140A connected to the bracket 104 so that the shaft 140 can remain fixed during rotation of the roller 114 relative to the bracket 104. The end 140A of the shaft 140 can extend through the coupler 134 for attachment to the bracket 104. The coupler 134 thus can rotate along with the roller 114 around the shaft 140.

The torsion spring 142 is disposed around the shaft 140. The torsion spring 142 can have one end 142A configured to remain fixed during rotation of the roller 114, and another end 142B rotationally coupled to the roller 114. For example, the end 142B of the torsion spring 142 can be connected to a rotary part 144 that is pivotally connected about an end 140B of the shaft 140 opposite to the end 140A thereof, the rotary part 144 being fitted into the roller 114 so that the roller 114 and the rotary part 144 are rotatable in unison relative to the shaft 140 and the bracket 104. As the roller 114 rotates for expanding the shade structure 112, the torsion spring 142 can store elastic energy. Once the shade structure 112 is released in a desired position, the elastic energy stored in the torsion spring 142 can assist in counteracting gravity action to keep the shade structure 112 in the desired position.

Referring to FIGS. 1 and 2, the two brackets 104 and 106, the coupler 108 and the connector 110 can be configured as an attachment system for fastening the shade assembly 102 to a support surface of a building. The bracket 106 and the connector 110 are attachable to a support surface of a building separate from the shade assembly 102. More specifically, the bracket 106 and the connector 110 are respectively attachable to a support surface of a building at two spaced-apart locations corresponding to the width dimension W of the shade assembly 102. The coupler 108 is coupled to the other end 102B of the shade assembly 102, and is operable to connect to and detach from the bracket 106. The bracket 104 is coupled to the end 102A of the shade assembly 102, and is operable to engage with and disengage from the connector 110. In this manner, the shade assembly 102 can be mounted to a support surface of a building by connecting the coupler 108 to the bracket 106 at the end 102B of the shade assembly 102 and by connecting the bracket 104 to the connector 110 at the other end 102A of the shade assembly 102.

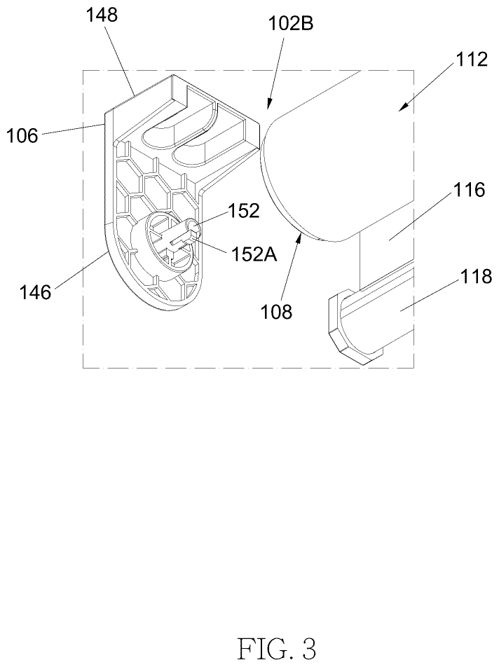

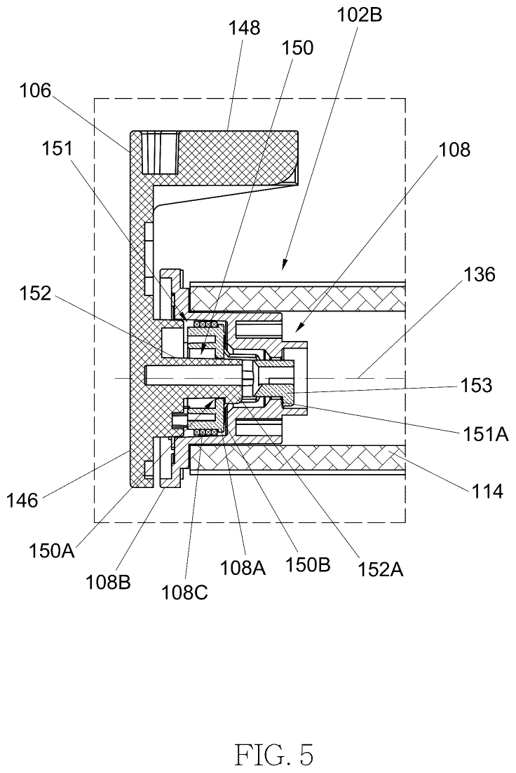

In conjunction with FIGS. 1 and 2, FIGS. 3 and 4 are perspective views illustrating construction details of the bracket 106 and the coupler 108 at the end 102B of the shade assembly 102, and FIG. 5 is a cross-sectional view illustrating the bracket 106 and the coupler 108 at the end 102B of the shade assembly 102 connected to each other. Referring to FIGS. 2-5, the bracket 106 can have a coupler mount portion 146, and an attaching portion 148 protruding sideways from the coupler mount portion 146. The coupler mount portion 146 and the attaching portion 148 can be fixedly connected to each other to form a bracket having a L-shape. According to an example of construction, the coupler mount portion 146 and the attaching portion 148 may be formed integrally as one single body. The attaching portion 148 of the bracket 106 is attachable to a support surface of a building via one or more fastener 149, e.g., via one or more screw. The coupler 108 at the end 102B of the shade assembly 102 is connectible to the coupler mount portion 146 of the bracket 106.

Referring to FIGS. 2-5, the coupler 108 is coupled to the end 114B of the roller 114 opposite to the bracket 104. According to an embodiment, the coupler 108 can include an anchor element 108A attachable to the coupler mount portion 146 of the bracket 106, and a rotary element 108B that is rotationally coupled to the end 114B of the roller 114 and is pivotally assembled around the anchor element 108A.

The anchor element 108A of the coupler 108 is operable to connect to and detach from the coupler mount portion 146 of the bracket 106. For example, the anchor element 108A of the coupler 108 can include a socket 150, and the coupler mount portion 146 of the bracket 106 can include a shaft portion 152 insertable into the socket 150 for connecting the coupler 108 to the bracket 106. To prevent an axial displacement that would separate the anchor element 108A of the coupler 108 from the bracket 106, the shaft portion 152 may have a resilient part 152A provided with a hook shape movable to engage with an end of the socket 150. When the coupler 108 is to be detached from the bracket 106, the shade assembly 102 can be pulled away from the coupler mount portion 146 of the bracket 106 so that the resilient part 152A is urged to move and disengage from the end of the socket 150.

Aside the foregoing example, it will be appreciated that other variant constructions are possible for detachably connecting the coupler 108 to the bracket 106. For example, a variant construction may omit the resilient part 152A. Moreover, the placement of the socket 150 and the shaft portion 152 may also be interchanged: the coupler mount portion 146 of the bracket 106 can have a socket similar to the socket 150, and the anchor element 108A of the coupler 108 can include a shaft portion insertable into the socket for connecting the coupler 108 to the bracket 106.

Referring to FIGS. 2-5, the rotary element 108B of the coupler 108 can have a portion that is fitted into the end 114B of the roller 114 so that the rotary element 108B of the coupler 108 and the roller 114 rotate in unison. To pivotally assemble the rotary element 108B around the anchor element 108A, the rotary element 108B can include an inner cavity 151 adapted to receive the anchor element 108A. The anchor element 108A may further include a resilient part 153 provided with a hook shape that is movable to engage with an opened end 151A of the inner cavity 151 in the rotary element 108B to prevent an axial displacement that separates the rotary element 108B from the anchor element 108A. According to an example of construction, the resilient part 153 may be formed integrally with the anchor element 108A. Once the coupler 108 is connected to the bracket 106, the rotary element 108B is rotatable along with the roller 114 relative to the anchor element 108A and the bracket 106. The engagement of the resilient part 153 with the opened end 151A can provide a locking strength that is greater than the locking strength provided by the engagement of the resilient part 152A with the socket 150 so that the anchor element 108A and the rotary element 108B can remain attached to each other when the shade assembly 102 is pulled away and detached from the coupler mount portion 146 of the bracket 106.

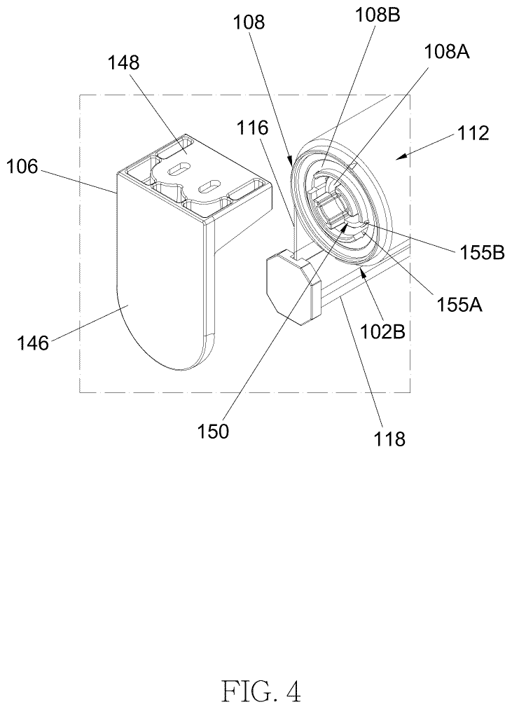

According to an example of construction, the coupler 108 may further include a spring 108C (better shown in FIG. 5) disposed around the anchor element 108A. More specifically, the spring 108C may be disposed in contact with a circumferential surface of the anchor element 108A inside the inner cavity 151 of the rotary element 108B, and the rotary element 108B can be disposed around the anchor element 108A and the spring 108C. The spring 108C can have one or two end (not shown) connected to the rotary element 108B. For example, the rotary element 108B can have a slot provided with two edge surfaces 155A and 155B (better shown in FIG. 4) opposite to each other that can respectively contact with two ends of the spring 108C. A frictional contact between the anchor element 108A and the spring 108C may provide some resistance to the rotation of the rotary element 108B and the roller 114, which may assist in maintaining the roller 114 stationary when the shade assembly 102 is not subjected to adjustment by a user. While the anchor element 108A of the coupler 108 remains connected to the bracket 106 and the bracket 104 remains engaged with the connector 110, the roller 114 and the rotary element 108B of the coupler 108 are rotatable in unison relative to the anchor element 108A, the brackets 104 and 106 and the connector 110 for retracting and expanding the shade structure 112, which can urge the spring 108C to loosen its frictional contact with the anchor element 108A so that the spring 108C can rotate along with the roller 114 and the rotary element 108B of the coupler 108.

Referring to FIGS. 2-5, the bracket 106 and the coupler 108 can be configured to allow movements of the shade assembly 102 for engaging and disengaging the other bracket 104 at the end 102A of the shade assembly 102 with respect to the connector 110 while the bracket 106 and the coupler 108 remain connected to each other. According to an example of construction, one of the bracket 106 and the coupler 108 can have a truncated conical shape that is positionable to contact with the other one of the bracket 106 and the coupler 108 for connecting the coupler 108 to the bracket 106. For example, the socket 150 can include a cavity having a truncated conical section, and the shaft portion 152 can be inserted into the socket 150 to be in contact with the truncated conical section. The engagement between the resilient part 152A of the shaft portion 152 and the socket 150 may also be configured to allow a movement of the shade assembly 102 for engaging and disengaging the bracket 104 with respect to the connector 110. For example, the end of the socket 150 may have an opening 150A, and the resilient part 152A may extend through the opening 150A and engage with an outer edge 150B of the opening 150A. The connection between the bracket 106 and the coupler 108 allows rotation of the roller 114 about the pivot axis 136 for winding and unwinding of the shade structure 112, and can form a fulcrum for movements of the shade assembly 102 to engage the bracket 104 with the connector 110 or disengage the bracket 104 from the connector 110.

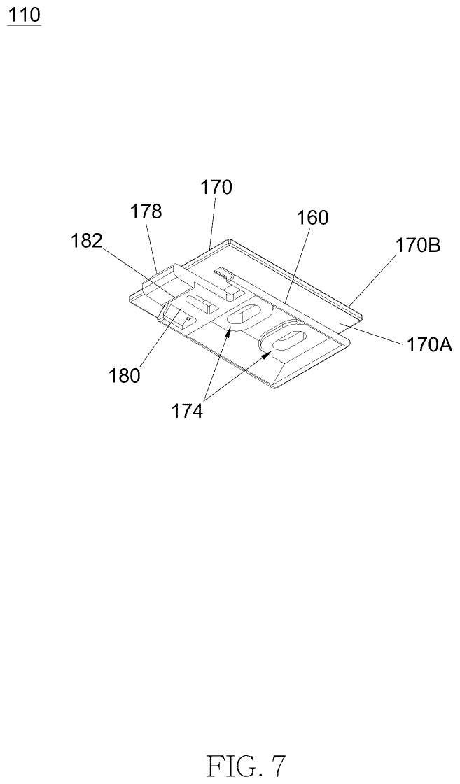

In conjunction with FIGS. 1 and 2, FIG. 6 is perspective view illustrating construction details of the connector 110 and the bracket 104 at the end 102A of the shade assembly 102, and FIG. 7 is a perspective view illustrating the connector 110 alone. Referring to FIGS. 1, 2, 6 and 7, while the coupler 108 at the end 102B of the shade assembly 102 remains connected to the bracket 106, the bracket 104 and the shade assembly 102 may be horizontally movable in unison to engage the bracket 104 with the connector 110 or disengage the bracket 104 from the connector 110. The bracket 104 can have a shade holding portion 154, and a bracket mount portion 156 protruding sideways from the shade holding portion 154.

According to an example of construction, the shade holding portion 154 and the bracket mount portion 156 can be fixedly connected to each other to form a bracket having a L-shape. For example, the shade holding portion 154 and the bracket mount portion 156 may be formed integrally as one single body. It will be appreciated, however, that the shade holding portion 154 and the bracket mount portion 156 may be separate parts fastened to each other.

The shade holding portion 154 of the bracket 104 is coupled to the end 102A of the shade assembly 102, in particular to the end 114A of the roller 114 and the end 140A of the shaft 140 of the torsion spring assembly 138. For example, the shaft 140 of the torsion spring assembly 138 and the coupler 134 that is rotationally coupled to the end 114A of the roller 114 may be coupled to a shaft portion (not shown) fixedly connected to the shade holding portion 154 of the bracket 104.

The bracket mount portion 156 of the bracket 104 is operable to engage with and disengage from the connector 110. While the connector 110 is attached to a support surface of a building, the bracket mount portion 156 of the bracket 104 can be engaged with the connector 110 so that the bracket 104 is held with the connector 110, or can be disengaged from the connector 110 for detaching the bracket 104 from the connector 110. Various constructions may be applied to provide a detachable connection between the bracket 104 and the connector 110.

FIGS. 6 and 7 illustrate an example of construction in which the bracket mount portion 156 of the bracket 104 can include a slot 158, and the connector 110 can include an insert 160 slidable into and out of the slot 158. The insert 160 can slide into the slot 158 for engaging the bracket 104 with the connector 110, and can slide out of the slot 158 for disengaging the bracket 104 from the connector 110.

Referring to FIGS. 6 and 7, the slot 158 can be formed on an outer surface of the bracket mount portion 156, can extend along an axis 162, and can have two openings 164 and 166 respectively located at two opposite ends 158A and 158B of the slot 158 along the axis 162. For connecting the bracket 104 to the connector 110, the bracket 104 is movable relative to the connector 110 along the axis 162 to slide the insert 160 into the slot 158 through the opening 164, and can slide along the axis 162 toward the other end 158B of the slot 158. The bracket mount portion 156 of the bracket 104 can have a stop 168 configured to stop the bracket 104 in position relative to the connector 110 as the insert 160 slides toward the end 158B of the slot 158. The stop 168 may be formed by any suitable structures. For example, the stop 168 may be formed by an inner portion of the slot 158 close to the opening 166 that extends transversally relative to the axis 162 of the slot 158. The insert 160 can slide along the slot 158 toward the end 158B thereof until the insert 160 contacts the stop 168 inside the slot 158, which can stop the bracket 104 relative to the connector 110.

Referring to FIGS. 6 and 7, the connector 110 can have a base portion 170 adapted to be attached to a support surface of a building, and the insert 160 can protrude from a side of the base portion 170. The insert 160 and the base portion 170 are fixedly connected to each other. For example, the insert 160 and the base portion 170 may be formed integrally as a single body. According to an example of construction, the base portion 170 can be shaped as a plate having two opposite surfaces 170A and 170B, the insert 160 can protrude from the surface 170A of the base portion 170, and the surface 170B of the base portion 170 is adapted to contact with a support surface of a building when the connector 110 is attached thereto.

The connector 110 may be attached to a support surface of a building with one or more fastener 172. For example, the connector 110 can include one or more hole 174 through which the one or more fastener 172 is engaged to attach the connector 110 to the support surface of the building. The one or more hole 174 may extend through the base portion 170 between the two opposite surfaces 170A and 170B thereof. During use, the one or more hole 174 can be covered by the bracket mount portion 156 of the bracket 104 when the bracket 104 is engaged with the connector 110 and exposed when the bracket 104 is disengaged from the connector 110.

Referring to FIGS. 6 and 7, the bracket 104 is movable relative to the connector 110 along the axis 162 to slide the insert 160 into the slot 158, and the slot 158 and the insert 160 may be configured so that an engagement of the insert 160 through the slot 158 is adapted to prevent detachment of the bracket 104 from the connector 110 along an axis 176 orthogonal to the axis 162 of the slot 158. Various constructions may be suitable to prevent detachment of the bracket 104 from the connector 110 along the axis 176 orthogonal to the axis 162. In the illustrated example, the insert 160 can have a tapered shape. The tapered shape of the insert 160 can widen as the tapered shape extends away from the base portion 170. When the insert 160 is engaged with the slot 158, a contact between the insert 160 and opposite sidewalls of the slot 158 can prevent a movement along the axis 176 that detaches the bracket 104 from the connector 110.

According to other examples not shown, the connector 110 may have a step-shaped insert that can likewise contact with corresponding sidewalls of the slot provided in the bracket 104 to prevent detachment of the bracket 104 from the connector 110 along the axis 176. In addition to or alternatively to a suitable shape of the insert 160, other embodiments may have one of the bracket 104 and the connector 110 provided with a lock (not shown), the lock being movable to engage with the other one of the bracket 104 and the connector 110 to prevent a movement along the axis 176 that detaches the bracket 104 from the connector 110.

Referring to FIGS. 6 and 7, a latch 178 may further be provided to prevent a movement of the bracket 104 that slides the insert 160 out of the slot 158. According to an example of construction, the latch 178 can include a resilient part 180 provided at an end of the insert 160. The latch 178 and the insert 160 may be formed integrally as a single body. For example, the resilient part 180 may be formed as an extension of the insert 160 having a distal end provided with a hook 182. The resilient part 180 may move relative to the insert 160 to have the hook 182 engaged with or disengaged from a sidewall 184 at the end 158B of the slot 158.

The insert 160 and the latch 178 can be introduced into the slot 158 from the end 158A of the slot 158, and are slidable along the slot 158 until the insert 160 contacts the stop 168 and the latch 178 protrudes outward from the opening 166 at the other end 158B of the slot 158. As the latch 178 protrudes outward from the opening 166, the hook 182 of the resilient part 180 can engage with the sidewall 184 at the end 158B of the slot 158. The engagement of the latch 178 with the sidewall 184 can prevent a movement of the bracket 104 along the axis 162 of the slot 158 that slides the insert 160 outward at the end 158A of the slot 158.

It will be appreciated that the latch 178 is not limited to the illustrated example. More generally, various latch constructions may be possible, wherein the latch can be coupled to one of the bracket 104 and the connector 110 at any suitable locations, the latch being movable to engage with the other one of the bracket 104 and the connector 110 to prevent a movement of the bracket 104 that slides the insert 160 outward at the end 158A of the slot 158.

Moreover, the detachable connection between the bracket 104 and the connector 110 is not limited to the aforementioned constructions. For example, the placement of the slot 158 and the insert 160 may be interchanged to provide a similar detachable connection: the slot 158 may be provided in the connector 110, and the insert 160 may be provided on the bracket mount portion 156 of the bracket 104, wherein the insert 160 is likewise slidable into and out of the slot 158 for connecting and detaching the bracket 104.

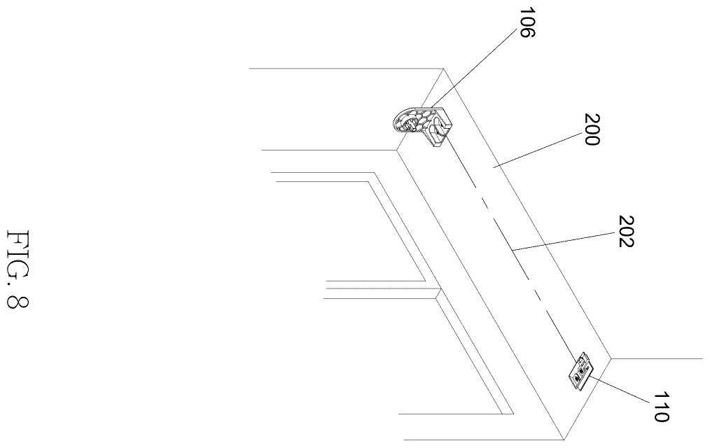

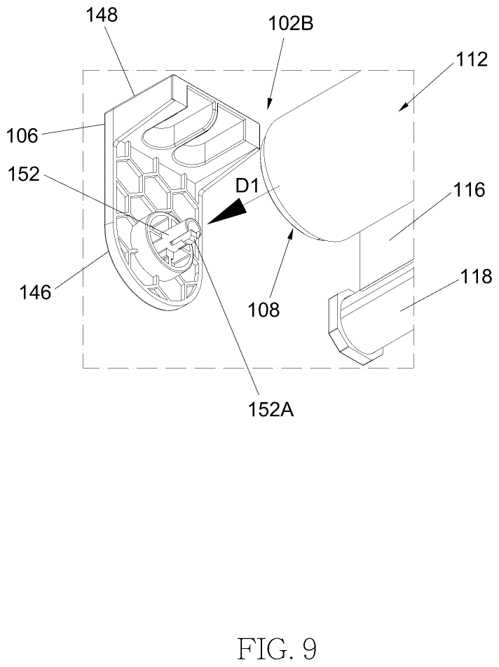

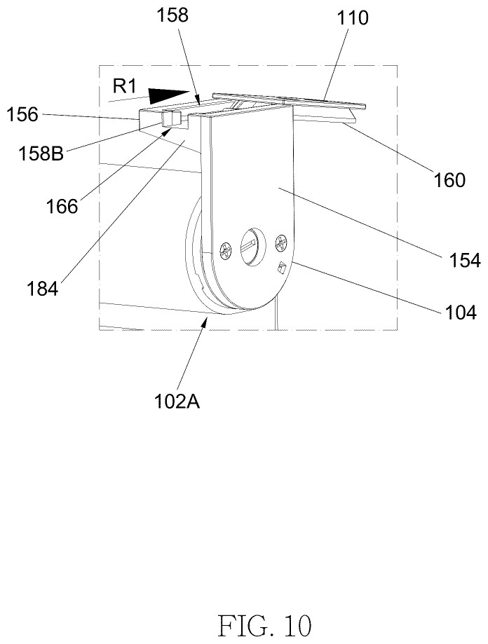

In conjunction with FIGS. 1-7, FIGS. 8-12 are schematic views illustrating exemplary operation for installing the window shade 100 to a support surface 200 of a building. Referring to FIGS. 1-8, the bracket 106 and the connector 110 first are respectively attached to the support surface 200 at two locations spaced apart from each other along a width axis 202 corresponding to the width dimension W of the shade assembly 102. The bracket 106 and the connector 110 are fixedly attached to the support surface 200 separate from the shade assembly 102. Once the bracket 106 and the connector 110 are fixedly attached to the support surface 200, the coupler mount portion 146 of the bracket 106 can extend vertically, and the attaching portion 148 of the bracket 106 can protrude horizontally from the coupler mount portion 146 toward the connector 110.

Referring to FIGS. 1, 2, 8 and 9, the shade assembly 102 having the two opposite ends 102A and 102B thereof respectively provided with the bracket 104 and the coupler 108 then can be moved along the width axis 202 in a direction D1 to connect the coupler 108 to the shaft portion 152 of the bracket 106. For example, the shade assembly 102 can be moved in the direction D1 until the resilient part 152A of the shaft portion 152 engages with the socket 150 in the anchor element 108A of the coupler 108.

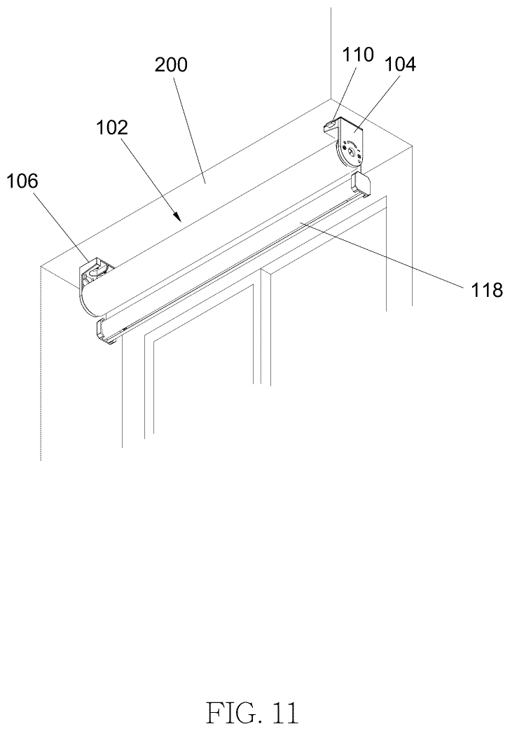

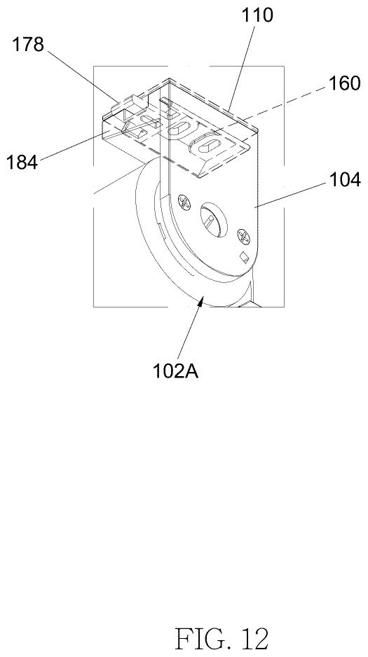

Referring to FIGS. 1, 2 and 8-10, while the coupler 108 at the end 102B of the shade assembly 102 remains connected to the shaft portion 152 of the bracket 106, the shade assembly 102 can be moved transversally relative to the width axis 202 in a direction R1 to engage the bracket 104 at the end 102A of the shade assembly 102 with the connector 110. As the shade assembly 102 moves in the direction R1, the insert 160 of the connector 110 is introduced through the opening 164 into the slot 158 of the bracket 104. The insert 160 can then slide along the slot 158 until the insert 160 contacts the stop 168 and the latch 178 protrudes outward from the opening 166 and engages with the sidewall 184 at the end 158B of the slot 158. The bracket 104 is thereby locked in position relative to the connector 110, which completes the installation of the window shade 100. FIG. 11 is a perspective view illustrating the window shade 100 fully mounted to the support surface 200 of the building, and FIG. 12 is an enlarged view illustrating the bracket 104 locked to the connector 110. Once the installation of the window shade 100 is completed, the coupler mount portion 146 of the bracket 106 and the shade holding portion 154 of the bracket 104 can extend vertically parallel to each other, and the attaching portion 148 of the bracket 106 and the bracket mount portion 156 of the bracket 104 can respectively protrude horizontally from the coupler mount portion 146 and the shade holding portion 154 toward each other. Moreover, the portion of the panel 116 wound around the roller 114 between the two brackets 104 and 106 can be exposed at a front of the window shade 100 facing indoor.

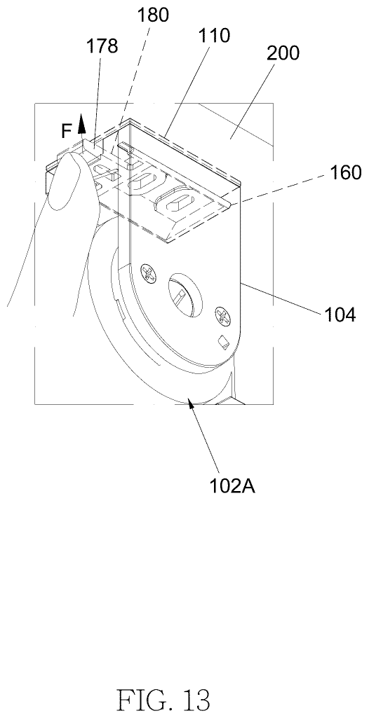

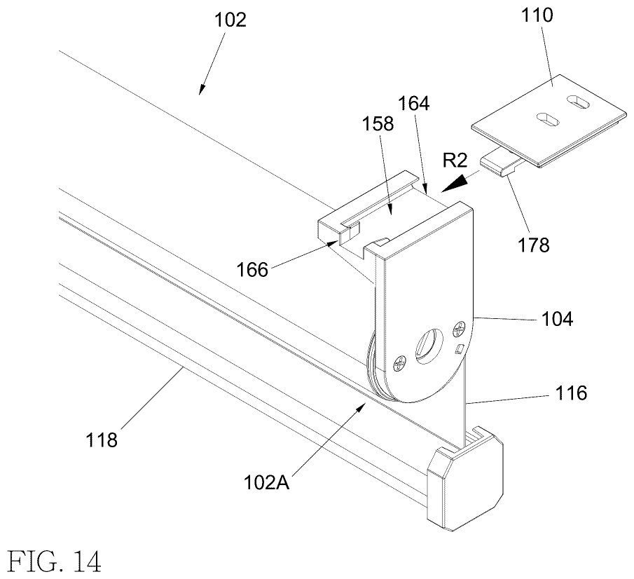

In conjunction with FIGS. 1-7, FIGS. 13 and 14 are schematic views illustrating exemplary operation for removing the shade assembly 102 from the support surface 200 of the building. First, a user can operate the latch 178 to unlock the bracket 104 from the connector 110. For example, the user can apply an upward force F that urges the resilient part 180 of the latch 178 to move and disengage from the sidewall 184 at the end 158B of the slot 158, which can unlock the latch 178. While the coupler 108 at the end 102B of the shade assembly 102 remains connected to the bracket 106, the shade assembly 102 and the bracket 104 then can be moved in unison relative to the bracket 106 and the connector 110 in a direction R2 opposite to the direction R1, which causes the insert 160 of the connector 110 to slide outward at the opening 164 and disengage from the slot 158 of the bracket 104. While the bracket 106 and the connector 110 remain attached to the support surface 200 of the building, the bracket 104 at the end 102A of the shade assembly 102 can be thereby detached from the connector 110, and the coupler 108 at the other end 102B of the shade assembly 102 then can be detached from the bracket 106 for removing the shade assembly 102 from the support surface 200 of the building.

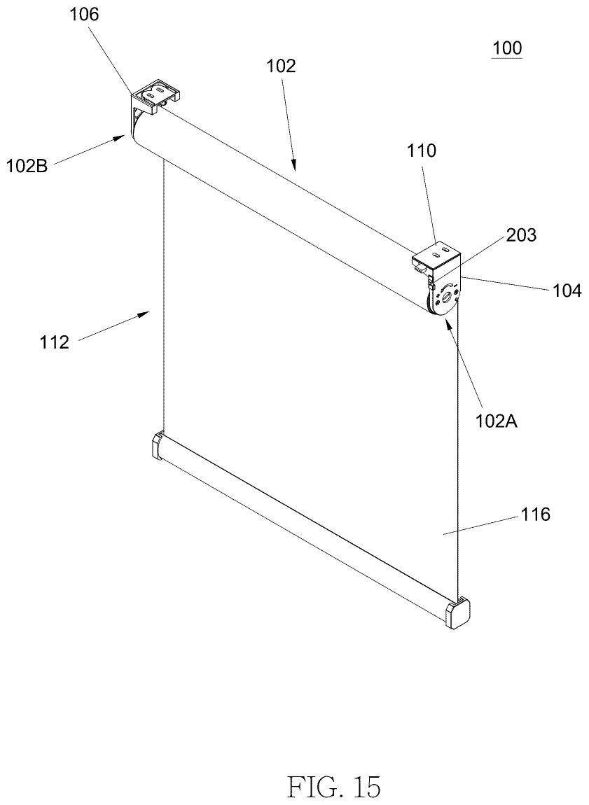

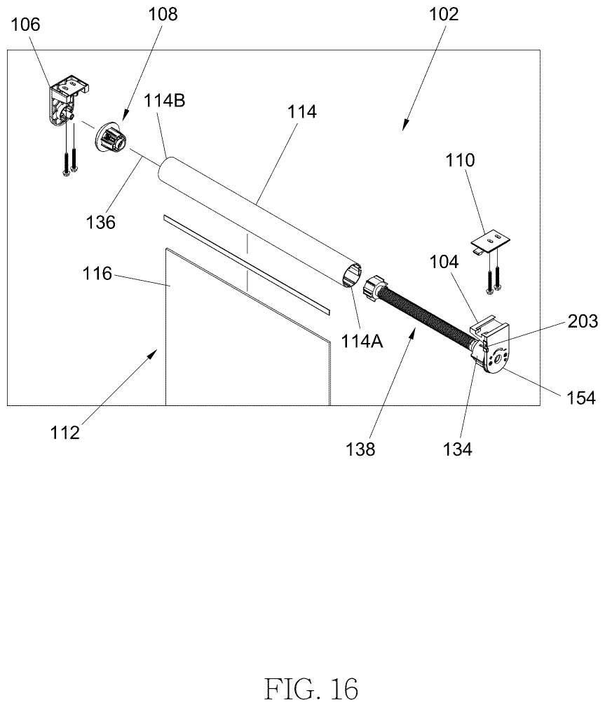

In conjunction with FIGS. 1-14, FIGS. 15 and 16 are respectively a perspective and an exploded view illustrating a variant embodiment of the window shade 100. Like previously described, the window shade 100 of FIGS. 15 and 16 can include the shade assembly 102 comprised of the shade structure 112 and the roller 114 connected to each other, and the torsion spring assembly 138 disposed inside the roller 114. The window shade 100 uses the attachment system including the two brackets 104 and 106, the coupler 108 and the connector 110 for fastening the shade assembly 102 to a support surface of a building. The two brackets 104 and 106, the coupler 108 and the connector 110 shown in FIGS. 15 and 16 can have the construction and operate like described previously for installation and removal of the shade assembly 102 on a support surface of a building.

Referring to FIGS. 15 and 16, the window shade 100 further includes a roller lock 203 provided on the bracket 104. The roller lock 203 is movable between a locking position where the roller lock 203 rotationally locks the roller 114, and an unlocking position where the roller lock 203 rotationally unlocks the roller 114. The roller 114 is prevented from rotating about the pivot axis 136 relative to the bracket 104 when the roller lock 203 is in the locking position, and is allowed to rotate about the pivot axis 136 relative to the bracket 104 when the roller lock 203 is in the unlocking position.

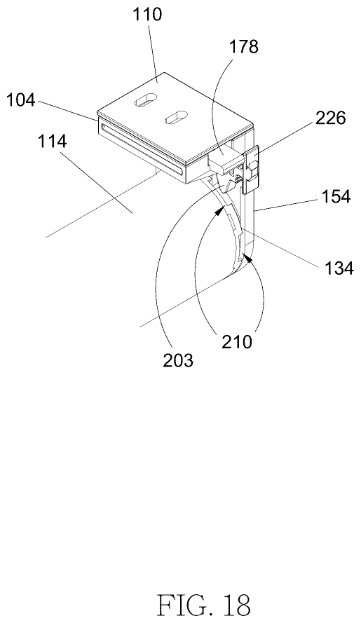

For locking and unlocking the roller 114, the roller lock 203 can be configured to move relative to the bracket 104 to engage with or disengage from the roller 114, or a part that is rotationally coupled to the roller 114. In conjunction with FIGS. 15 and 16, FIGS. 17 and 18 are perspective views illustrating construction details of the roller lock 203. Referring to FIGS. 15-18, the roller lock 203 can be slidably connected to the bracket 104 for sliding movements between the locking position and the unlocking position. For example, the shade holding portion 154 of the bracket 104 can have a guide slot 204, and the roller lock 203 can be disposed for sliding along the guide slot 204. A fastener 206 may be engaged through an elongate opening 208 of the roller lock 203 with the shade holding portion 154 of the bracket 104 to hold the roller lock 203 with the bracket 104.

In the illustrated example, the roller lock 203 is arranged to slide vertically between the locking position and the unlocking position while the shade assembly 102 is installed to a support surface of a building. However, the roller lock 203 may be disposed to slide along a different direction. Moreover, the connection between the bracket 104 and the roller lock 203 is not limited to sliding connections. Another example may have the roller lock 203 pivotally connected to the bracket 104 so that the roller lock 203 is rotatable between the locking position and the unlocking position. Accordingly, various suitable constructions may be applied to movably connect the roller lock 203 to the bracket 104.

Referring to FIGS. 15-18, the roller lock 203 can move toward the roller 114 to the locking position, and away from the roller 114 to the unlocking position. For example, the roller lock 203 can engage with the coupler 134 at the end 114A of the roller 114 in the locking position, and disengage from the coupler 134 in the unlocking position. According to an example of construction, the coupler 134 can have a portion exposed at the end 114A of the roller 114 that has a circumference provided with a plurality of lock openings 210 angularly spaced-apart from one another, and the roller lock 203 can engage with any of the lock openings 210 in the locking position.

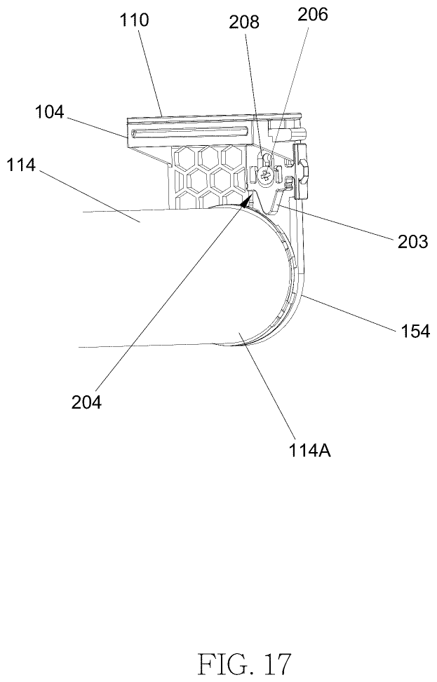

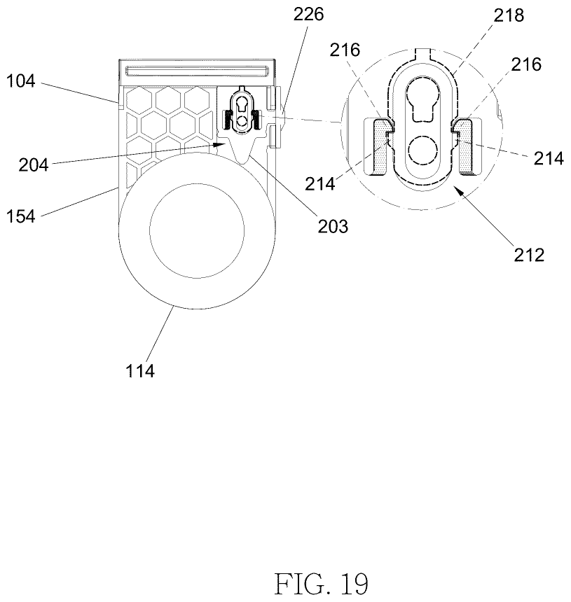

In conjunction with FIGS. 17 and 18, FIG. 19 is a schematic view illustrating a stop mechanism 212 for holding the roller lock 203 in the unlocking position. Referring to FIG. 19, the stop mechanism 212 can include at least one detent protrusion 214 fixedly connected to the shade holding portion 154 of the bracket 104, and at least one catching portion 216 coupled to the roller lock 203. The catching portion 216 of the roller lock 203 can engage with the detent protrusion 214 on the bracket 104 for holding the roller lock 203 in the unlocking position. According to an example of construction, two detent protrusions 214 can be respectively disposed at two opposite sides of a protruding structure 218 that is provided on the shade holding portion 154 of the bracket 104, and the roller lock 203 can have two catching portions 216 respectively corresponding to the two detent protrusions 214. Each of the two catching portions 216 can be exemplarily a resilient part formed integrally with the roller lock 203 as a single body, and can have a hooked end adapted to engage with the corresponding detent protrusion 214. As the roller lock 203 moves to the unlocking position, the catching portions 216 can elastically flex and respectively engage with the detent protrusions 214 to hold the roller lock 203 in the unlocking position. A user can urge the roller lock 203 toward the locking position to force the catching portions 216 to elastically flex and disengage from the detent protrusions 214.

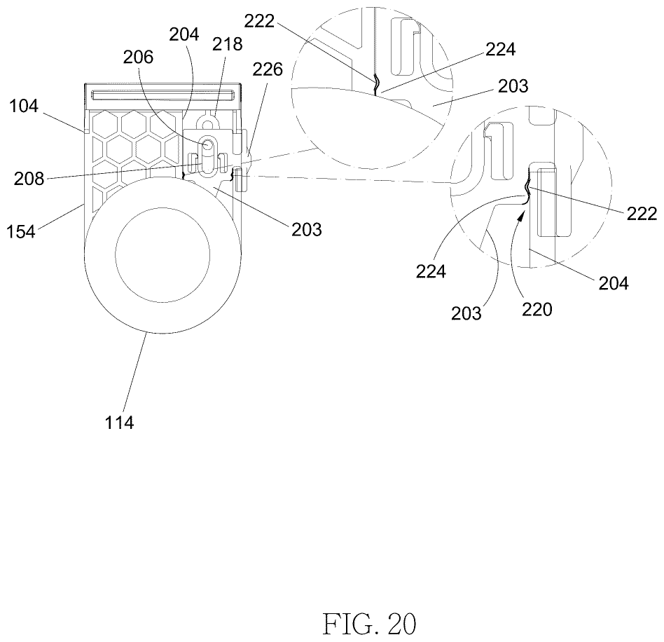

FIG. 20 is a schematic view illustrating a stop mechanism 220 for holding the roller lock 203 in the locking position. Referring to FIG. 20, the stop mechanism 220 can include at least one detent protrusion 222 fixedly connected to the shade holding portion 154 of the bracket 104, and at least one detent protrusion 224 provided on the roller lock 203. The detent protrusion 224 on the roller lock 203 can engage with the detent protrusion 222 on the bracket 104 for holding the roller lock 203 in the locking position. According to an example of construction, two detent protrusions 222 can be respectively provided on two opposite side edges of the guide slot 204, and the roller lock 203 can have two detent protrusions 224 respectively protruding from two opposite side edges of the roller lock 203. As the roller lock 203 moves to the locking position, the detent protrusions 224 can respectively engage with the detent protrusions 222 to hold the roller lock 203 in the locking position. A user can urge the roller lock 203 toward the unlocking position to force the detent protrusions 224 to disengage from the detent protrusions 222.

The stop mechanisms 212 and 220 described herein can be applied separately and independently of each other for holding the roller lock 203 in different positions. According to another example not shown, the stop mechanisms may be configured to interact with each other for holding the roller lock 203 in two different positions: one of the two stop mechanisms may have a spring that biases the roller lock 203 toward one of the two positions, and the other one of the two stop mechanisms may include an engagement that can keep the roller lock 203 in the other one of the two positions against the spring action. Accordingly, various constructions of the stop mechanisms are possible.

Referring to FIGS. 17-20, the roller lock 203 may have an actuating part 226 for facilitating manual operation by a user. The actuating part 226 protrude from a side of the roller lock 203, and may be exposed at a front of the shade assembly 102. According to an example of construction, the actuating part 226 may be formed integrally with the roller lock 203 as a single body. The actuating part 226 may have any suitable structure that can facilitate manual operation of the roller lock 203 with one finger, which can include, without limitation, a knob or any protruding structure provided on a surface of the actuating part 226.

Exemplary operation of the roller lock 203 is described hereinafter with reference to FIGS. 19 and 20. In FIG. 19, the roller lock 203 is shown in the unlocking position. To prevent rotation of the roller 114, a user can apply a force on the actuating part 226 to urge the roller lock 203 toward the locking position. As result, the catching portions 216 of the roller lock 203 are forced to flex and disengage from the detent protrusions 214 on the bracket 104. As the roller lock 203 moves and reaches the locking position shown in FIG. 20, the detent protrusions 224 on the roller lock 203 can respectively engage with the detent protrusions 222 on the bracket 104 to hold the roller lock 203 in the locking position. While the roller lock 203 is in the locking position, the roller 114 cannot rotate relative to the bracket 104.

To allow rotation of the roller 114, the user can apply a force on the actuating part 226 to urge the roller lock 203 toward the unlocking position. As result, the detent protrusions 224 on the roller lock 203 are forced to disengage from the detent protrusions 222 on the bracket 104. As the roller lock 203 moves and reaches the unlocking position shown in FIG. 19, the catching portions 216 of the roller lock 203 elastically flex and engage with the detent protrusions 214 on the bracket 104 to hold the roller lock 203 in the unlocking position.

The ability to rotationally lock the roller 114 can facilitate transport and installation of the shade assembly 102. For example, the roller 114 can be locked by the roller lock 203 while a user proceeds for mounting the shade assembly 102 to a support surface of a building. During the installation of the shade assembly 102, the locking engagement of the roller lock 203 can prevent any undesirable rotations of the roller 114, such as a rotation induced by the torque applied by the torsion spring assembly 138. Once the installation of the shade assembly 102 is completed (such as shown in FIG. 11), the roller lock 203 can be switched to the unlocking position to release the roller 114 for rotation.

It will be appreciated that the roller lock and the elements related thereto are not limited to the examples of window shade constructions described herein. For example, the roller lock described herein may be used in window shades that have the two brackets at the two ends of the roller connected to a head rail, which is affixed to a support surface of a building via any suitable attachment devices engaged with the head rail. Accordingly, it is understood that the roller lock described herein could be generally suitable for use with any window shades having a shade structure operated with a roller.

Advantages of the structures described herein include the ability to provide a window shade that needs no elongate head rail, which can reduce the weight of the window shade. Moreover, the window shade can have an attachment system and a roller lock that can facilitate transport, installation and removal the shade assembly.

Realizations of the structures have been described only in the context of particular embodiments. These embodiments are meant to be illustrative and not limiting. Many variations, modifications, additions, and improvements are possible. These and other variations, modifications, additions, and improvements may fall within the scope of the claims that follow.

What is claimed is:

1. A window shade comprising:
a shade assembly including a roller and a shade structure connected to each other, the shade assembly having a first end and a second end opposite to each other, the first end being coupled to a first bracket, the second end having a coupler, the roller being pivotally connected to the first bracket;
a roller lock provided on the first bracket, wherein the roller lock is movable between a locking position where the roller lock rotationally locks the roller to prevent rotation of the roller relative to the first bracket, and an unlocking position where the roller lock rotationally unlocks the roller for rotation of the roller relative to the first bracket; and
a connector and a second bracket attachable to a support surface of a building, wherein the first bracket and the coupler are respectively connected to the connector and the second bracket when the shade assembly is mounted to the support surface of the building.

2. The window shade according to claim 1, wherein the roller lock is slidably connected to the first bracket.

3. The window shade according to claim 1, wherein the roller lock is movable relative to the first bracket to engage with and disengage from the roller, or a part that is rotationally coupled to the roller.

4. The window shade according to claim 1, wherein the roller is pivotally connected to the first bracket via a second coupler that is fitted at least partially into one end of the roller, and the roller lock engages with the second coupler in the locking position and disengages from the second coupler in the unlocking position.

5. The window shade according to claim 4, wherein the second coupler has a circumference provided with a plurality of lock openings angularly spaced-apart from one another, and the roller lock engages with any of the lock openings in the locking position.

6. The window shade according to claim 1, further including a first stop mechanism for holding the roller lock in the unlocking position, and a second stop mechanism for holding the roller lock in the locking position.

7. The window shade according to claim 6, wherein the first stop mechanism includes at least one detent protrusion fixedly connected to the first bracket, and at least one catching portion coupled to the roller lock, the catching portion engaging with the detent protrusion for holding the roller lock in the unlocking position.

8. The window shade according to claim 6, wherein the second stop mechanism includes at least one first detent protrusion fixedly connected to the first bracket, and at least one second detent protrusion provided on the roller lock, the second detent protrusion engaging with the first detent protrusion for holding the roller lock in the locking position.

9. The window shade according to claim 1, wherein the roller lock has an actuating part for facilitating manual operation by a user, the actuating part protruding from a side of the roller lock and being exposed at a front of the shade assembly.

10. The window shade according to claim 1, wherein the connector and the second bracket are attachable to the support surface of the building separate from the shade assembly, the first bracket is operable to engage with and disengage from the connector, and the coupler is operable to connect to and detach from the second bracket.

11. The window shade according to claim 1, wherein the second bracket and the coupler at the second end of the shade assembly are configured to allow a movement of the shade assembly for engaging and disengaging the first bracket with respect to the connector while the coupler and the second bracket remain connected to each other.

12. The window shade according to claim 11, wherein while the coupler at the second end of the shade assembly remains connected to the second bracket, the first bracket and the shade assembly are horizontally movable in unison to engage the first bracket with the connector or disengage the first bracket from the connector.

13. The window shade according to claim 1, wherein the connector and the second bracket are respectively attachable to a support surface of a building at two locations spaced apart from each other along a width axis corresponding to a width dimension of the shade assembly, the shade assembly being movable along the width axis to connect the coupler at the second end of the shade assembly to the second bracket, and the shade assembly being movable transversally relative to the width axis to engage the first bracket at the first end of the shade assembly with the connector while the coupler remains connected to the second bracket.

14. The window shade according to claim 1, wherein one of the coupler and the second bracket has a truncated conical shape that is positionable to contact with the other one of the coupler and the second bracket for connecting the coupler to the second bracket.

15. The window shade according to claim 1, wherein the second bracket has a coupler mount portion, and an attaching portion protruding sideways from the coupler mount portion, the coupler at the second end of the shade assembly being connectible to the coupler mount portion, and the attaching portion being attachable to a support surface of a building via one or more fastener.

16. The window shade according to claim 15, wherein one of the coupler and the coupler mount portion includes a socket, and the other one of the coupler and the coupler mount portion includes a shaft portion insertable into the socket for connecting the coupler to the second bracket.

17. The window shade according to claim 16, wherein the shaft portion includes a resilient part movable to engage with and disengage from the socket, an engagement of the resilient part with the socket allowing a movement of the shade assembly for engaging and disengaging the first bracket with respect to the connector.

18. The window shade according to claim 1, wherein the first bracket has a shade holding portion, and a bracket mount portion protruding sideways from the shade holding portion, the shade holding portion being coupled to the first end of the shade assembly, and the bracket mount portion being operable to engage with and disengage from the connector.

19. The window shade according to claim 18, wherein one of the connector and the bracket mount portion includes a slot, and the other one of the connector and the bracket mount portion includes an insert slidable into and out of the slot.

20. The window shade according to claim 19, wherein the first bracket at the first end of the shade assembly is movable relative to the connector along a first axis to slide the insert into the slot, an engagement of the insert through the slot being adapted to prevent detachment of the first bracket from the connector along a second axis orthogonal to the first axis.

21. The window shade according to claim 19, further including a latch configured to prevent a movement of the first bracket that slides the insert out of the slot.

22. The window shade according to claim 21, wherein the latch is coupled to one of the first bracket and the connector, the latch being movable to engage with the other one of the first bracket and the connector to prevent a movement of the first bracket that slides the insert out of the slot.

23. The window shade according to claim 21, wherein the insert is introduced into the slot from a first end of the slot, and is slidable along the slot until the insert contacts a stop inside the slot and the latch protrudes outward at a second end of the slot opposite to the first end thereof.

24. The window shade according to claim 19, wherein the insert has a tapered shape.

25. The window shade according to claim 1, wherein the coupler includes:
an anchor element attachable to the second bracket;
a spring disposed around the anchor element; and
a rotary element rotationally coupled to the roller and disposed around the anchor element and the spring.

26. The window shade according to claim 1, wherein the shade assembly further includes a torsion spring assembly disposed inside the roller, the torsion spring assembly being adapted to apply a torque that tends to rotate the roller for winding the shade structure.
